(19) United States
(12) Patent Application Publication
(10) Pub. No.: US 2024/0109050 A1
(43) Pub. Date: Apr. 4, 2024

(54) ADSORPTION COMPOSITION FROM PALM FIBERS

(71) Applicants: SAUDI ARABIAN OIL COMPANY, Dhahran (SA); KING FAHD UNIVERSITY OF PETROLEIM & MINERALS, Dhahran (SA)

(72) Inventors: Rayan M. Nasser, Fordos (SA); Subhi A. Alaama, Khobar City (SA); Muhammad B. Rayaan, Dammam (SA); Bassam S. Tawabini, Dhahran (SA); Tawfik A. Awadh, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/478,969

(22) Filed: Sep. 29, 2023

Related U.S. Application Data
(60) Provisional application No. 63/412,050, filed on Sep. 30, 2022.

(51) Int. Cl. B01J 20/20; B01J 20/28; B01J 20/32; C02F 1/28

(52) U.S. Cl. CPC B01J 20/20; B01J 20/28007; B01J 20/28011; B01J 20/28026; B01J 20/28064; B01J 20/28066; B01J 20/3204; B01J 20/3217; B01J 20/3244; B01J 20/3293; C02F 1/283; C02F 2101/322

(57) ABSTRACT

An adsorption composition that includes a treatment agent including a material having an oxidized surface functionality and a carrier fluid are described. A method of preparing an adsorption composition including processing a material derived from at least one component of a date tree to provide a processed date tree material, treating the processed date tree material with a first treatment to produce a treated date tree material, reacting the treated date tree material with one or more oxidizing agents to form a treatment agent, and suspending the treatment agent in a carrier fluid is also described. Further, a method of adsorbing one or more compounds from a water-based fluid including introducing an adsorption composition to a water-based fluid containing one or more organic compounds contacting the adsorption composition with the one or more organic compounds and adsorbing the one or more organic compounds on the treatment agent is also described.

### BACKGROUND

In many industries, active resource legislation and policies dictate operating parameters and regulations for reducing organic content to a minimum quantity in water resources. Organic content may include oil, organic toxins, and total organic carbon counts, among others. Some regulations include prevention of contamination of precious resources including groundwater. In the oil and gas industry, groundwater contamination can be caused by operational deficiencies such as spills, leaks, and overfills. In particular, groundwater contamination poses a major threat, as contaminants in water and water sources can significantly and negatively affect health for individuals and communities that utilize groundwater as their main source for water consumption.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an adsorption composition that includes a treatment agent including a material having an oxidized surface functionality and a carrier fluid., The material is selected from the group consisting of pyrolyzed carbon, activated carbon, and combinations thereof. In another aspect, embodiments disclosed herein relate to a method of preparing an adsorption composition. The method includes processing a material derived from at least one component of a date tree to provide a processed date tree material, treating the processed date tree material with a first treatment to produce a treated date tree material, reacting the treated date tree material with one or more oxidizing agents to form a treatment agent, and suspending the treatment agent in a carrier fluid.

In another aspect, embodiments disclosed herein relate to a method of adsorbing one or more compounds from a water-based fluid including introducing an adsorption composition to a water-based fluid containing one or more organic compounds. The adsorption composition includes a carrier fluid and a treatment agent that includes a material having an oxidized surface functionality. The material is selected from the group consisting of pyrolyzed carbon, activated carbon, and combinations thereof. The method also includes contacting the adsorption composition with the one or more organic compounds and adsorbing the one or more organic compounds on the treatment agent.

Other aspects and advantages of the claimed subject matter will be apparent from the following description and the appended claims.

### BRIEF DESCRIPTION OF DRAWINGS

FIGS. 1A-1C are schematics of the surface functionality of treated date tree material, an oxidized date tree material, and a treatment agent in accordance with one or more embodiments.

FIG. 2 is a block flow diagram of a method of preparing an adsorption composition in accordance with one or more embodiments.

FIG. 3 is block flow diagram of a method to adsorb one or more compounds from a water-based fluid in accordance with one or more embodiments.

FIG. 4 is a schematic of providing an adsorption composition from a fibrous component of a date tree in accordance with one or more embodiments.

### DETAILED DESCRIPTION

Groundwater is a precious non-renewable resource for many countries, communities, and industries. Groundwater scarcity exacerbated by excessive withdrawal and/or contamination are considered environmental and communal threats to local communities that experience already water-stressed economies. Groundwater is particularly susceptible to contamination when in close proximity to industries and products that incorporate toxic and hazardous compounds. Specifically, organic compounds with substantial environmental and biological hazardous effects can be problematic. Methods to remove contaminants, such as organic compounds, include immobilization, encapsulation, bio-removal, and adsorption.

Adsorption is often performed using a porous material, which can increase a rate of molecular adsorption/desorption. In particular, bio-mass derived carbonaceous material, such as pyrolyzed carbon or activated carbon derived from bio-mass sources, is an attractive porous material for adsorption/desorption applications. However, due to the diversity of bio-mass sources, generation of uniform physical characteristics in carbonaceous material increases in complexity and difficulty.

One or more embodiments of the present disclosure relate to an adsorption composition and methods for production and use thereof that provide adsorption of one or more compounds from a water-based fluid. Production of the adsorption composition may provide a uniform carbonaceous material. In one or more embodiments, the adsorption composition and methods of use may be useful for the removal of one or more compounds from a water-based fluid.

### ADSORPTION COMPOSITION

In one aspect, embodiments disclosed herein relates to an adsorption composition. The adsorption composition may include a carrier fluid and a treatment agent. In one or more particular embodiments, the adsorption composition is a suspension of the treatment agent in the carrier fluid. The treatment agent may be sufficiently suspended in the carrier fluid such that the treatment agent may be considered a liquified treatment agent. The treatment agent may be sufficiently suspended in the carrier fluid such that the adsorption composition is a homogenous mixture. The treatment agent may remain suspended for at least about several hours. If after several hours, the treatment agent settles or agglomerates in the carrier fluid, the fluid may be mixed such that the treatment agent is resuspended to provide a homogeneous mixture.

In one or more embodiments, the adsorption composition may be referred to as a liquified activated carbon, liquified pyrolyzed carbon, or combinations thereof. In such instances, “a liquified activated carbon” or “a liquified pyrolyzed carbon” refers to an activated carbon or a pyrolyzed carbon that is suspended in a liquid allowing for delivery of the solid carbon material in liquid form. This form may be particularly advantageous for remediation purposes as explained below.

In one or more embodiments, the carrier fluid may be an aqueous fluid. The aqueous fluid may be distilled water, brine, deionized water, tap water, fresh water from surface or subsurface sources, formation water produced from the structural low, formation water produced from a different geologic formation, production water, frac or flowback water, natural and synthetic brines, residual brine from desalination processing, a regional water source, such as fresh water, brackish water, natural and synthetic sea water, potable water, non-potable water, ground water, seawater, other waters, and combinations thereof, that are suitable for use in a wellbore environment. In one or more embodiments, the water used may naturally contain contaminants, such as salts, ions, minerals, organics, and combinations thereof, as long as the contaminants do not interfere with the suspension of the treatment agent, the removal of one or more compounds from a second water-based fluid, or both. In one or more embodiments, the water-based fluid includes additives such as viscosifiers, polymers, surfactants, and combinations thereof.

In one or more embodiments, the adsorption composition includes a suspension stabilizer. The suspension stabilizer may prevent agglomeration of a treatment agent of the adsorption composition. The suspension stabilizer may be a polymeric stabilizer. The polymeric stabilizer may include a polymer selected from the group consisting of polyethyleneimine, ethyleneimine, ethylene amine, and combinations thereof.

In one or more embodiments, the treatment agent may be derived from a bio-mass source. The bio-mass source can include one or more components derived from a date tree. The one or more date tree derived components may include a fibrous component, such as a date tree fiber. The date tree fiber has the advantage of being a waste product that is highly abundant in many areas of oil and gas operations, and it also possesses unique physical properties making it a good candidate for a carbonaceous material source.

The date tree fiber may include date tree trunk fibers produced from date tree trunks, date tree leaf and leaf stem fibers produced from date tree leaves and leaf stems, and date tree panicle fibers produced from date tree panicles. As will be appreciated, each date tree panicle may include date tree spikelets, which, in some embodiments, may also be used in the formation of fibers from the date tree panicles.

In one or more embodiments, the date tree fiber may be prepared by collecting deceased date palm trees, drying the date trees to a moisture content of less than 4% by mass, cleaning the date trees using high pressure air, chopping the date trees into logs around 1.5 feet in length, grinding the date trees to produce the fiber mix. In some embodiments, the date palm fiber mix may include fibers having a particle size distribution that may be referred to as course, medium, fine, or super fine. In one or more embodiments, the fibers may be ground or milled to produce a specific fiber size that may be tailorable to a specific pore size. In one or more embodiments, the fiber mix is sieved with 0.5 to 4 mm sieves and separating the ground fibers to obtain sieved fibers having an average length of 0.5 to 4 mm.

In one or more embodiments, the length of the sieved fibers may range from 0.5 to 4 millimeters (mm). In one or more embodiments, the length of the fibers may have a lower limit of one of about 0.5 mm, about 0.65 mm, about 0.75 mm, about 0.9 mm, about 1.0 mm, and about 1.25 mm and an upper limit of one of about 1.5 mm, about 1.75 mm, about 2.0 mm, about 2.5 mm, about 3.0 mm, and about 4.0 mm, where any lower limit may be paired with any mathematically compatible upper limit.

In one or more embodiments, the diameter of the fibers may range from 50 nanometers (nm) to 0.1 micrometers (μm). In one or more embodiments, the diameter of the fibers may have a lower limit of one of about 50 nm, about 60 nm, about 70 nm, about 75 nm, and about 80 nm and an upper limit of one of about 25 nm, about 40 nm, about 50 nm, about 60 nm, about 75 nm , and about 0.1 micrometers (μm), where any lower limit may be combined with any mathematically compatible upper limit.

The fibers may be further modified to provide a treatment agent of one or more embodiments. The treatment agent may be a water remediation agent. The adsorption composition may include the treatment agent suspended or dispersed in the carrier fluid in an amount that ranges from about 1 wt. % (weight percent) to about 20 wt. % based on the total weight of the adsorption composition. The treatment agent may be included in the carrier fluid in an amount having a lower limit of one of about 1 wt. %, about 2 wt. %, about 5 wt. %, about 7.5 wt. %, about 10 wt. %, about 12.5 wt. % and about 15 wt. % and an upper limit of one of about 5 wt. %, about 7.5 wt. %, about 10 wt. %, about 15 wt. %, and about 20 wt. % based on the total weight of the adsorption composition, where a value of the lower limit may be paired with a value of a mathematically compatible upper limit.

The treatment agent of one or more embodiments may be a carbonaceous material. In particular embodiments, it may be a polyaromatic carbon material. For example, in one or more embodiments, the treatment agent may be selected from the group consisting of activated carbon, pyrolyzed carbon, and combinations thereof. Pyrolyzed carbon, activated carbon, or both may be particularly useful for one or more embodiments of the present disclosure because a high surface area and pore volume allow for a large relative amount of surface functionality per mass of carbon as a treatment agent.

In one or more embodiments, the treatment agent may be a pyrolyzed carbon. As used herein, “pyrolyzed carbon” refers to a carbon material that is processed to have high surface area and pore volume. In general, a pyrolyzed carbon may have a surface area of from 1 m²/g (meters squared per gram) to 500 m²/g and a pore volume of from 0.1 cm³/g (milliliters per gram) to 0.5 cm³/g.

In one or more embodiments, the treatment agent may be an activated carbon. As used herein, “activated carbon” refers to a carbon material that is processed to have high surface area and pore volume, and in particular, a higher surface area and pore volume than a pyrolyzed carbon. In general, an activated carbon may have a surface area of from 500 m²/g (meters squared per gram) to 3000 m²/g and a pore volume of from 0.5 mL/g (milliliters per gram) to 1.5 mL/g. An activated carbon material may be particularly useful for one or more embodiments of the present disclosure because a high surface area and pore volume allow for a large relative amount of surface functionality per mass of carbon as a treatment agent.

In one or more embodiments, the treatment agent may have a particle size suitable for use as a remediation material. The treatment agent may be made up of particles having a roughly spherical shape, or they may be irregular in shape. In one or more embodiments, the particles may have an average particle size with a lower limit of any one of about 0.1 (micrometers) μm, about 0.5 μm, about 1 μm, about 2.5 μm, about 5 μm, about 7.5 μm, and about 10 μm and an upper limit of any one of about 2.5 μm, about 5 μm, about 7.5 μm, about 10 μm, about 12.5 μm, and about 15 μm, where a value of the lower limit can be used in combination with a value of a mathematically compatible upper limit. Thus, the pyrolyzed carbon, activated carbon, or both may have particle sizes that are microscale. The treatment agent, prior to being combined with the carrier fluid, may be in the form of a powder.

In one or more embodiments, the treatment agent has a suitably high surface area for the treatment agent to adsorb a sufficient amount of organic compounds in a water-based fluid. The surface area of the pyrolyzed carbon, activated carbon, or both is an important property as a higher surface area carbon provides a greater adsorption surface per mass of the treatment agent. As one of ordinary skill may appreciate, the surface area of the activated carbon may be measured with a Brunauer-Emmett-Teller (BET) surface analysis technique. The treatment agent may have a surface area in a range with a lower limit of any one of about 600 m²/g (meters squared per gram), about 620 m²/g, about 640 m²/g, about 670 m²/g, about 700 m²/g, about 800 m²/g, about 900 m²/g, about 1000 m²/g, and about 1100 m²/g with an upper limit of any one of about 1000 m²/g, about 1100 m²/g, about 1200 m²/g, about 1300 m²/g, about 1450 m²/g, about 1480 m²/g, about 1490 m²/g, and about 1500 m²/g, where a value of the lower limit can be used in combination with a value of a mathematically compatible upper limit.

The treatment agent of one or more embodiments may have a structural stability to withstand water treatment conditions. Thus, the treatment agent does not chemically degrade or breakdown under water treatment conditions. Furthermore, in such embodiments, the treatment agent has a compatible surface to physically associate to (or “adsorb”) at least one organic compound in a water-based fluid containing at least one organic compound.

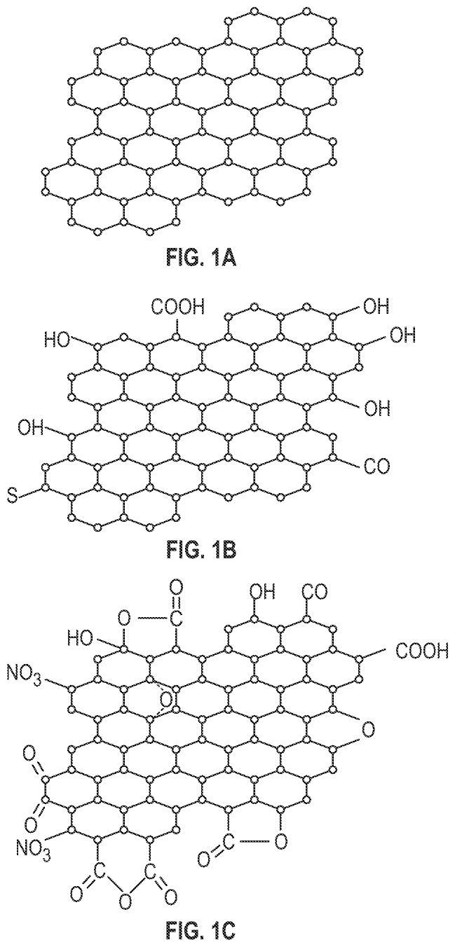

As mentioned above, the treatment agent may have an oxidized surface functionality. A non-limiting example of polyaromatic material without an oxidized surface functionality is shown in FIG. 1A. In the embodiment shown in FIG. 1A, the polyaromatic material is a crystalline polyaromatic material, such as graphene or graphite. However, the polyaromatic material may be a crystalline material, an amorphous material, or a mixture of both crystalline and amorphous domains. This unoxidized material may undergo transformation to introduce one or more oxidized carbon sites on the polyaromatic material as shown in FIG. 1B. These sites may be further oxidized to provide a treatment agent with oxidized surface functionalities as shown in FIG. 1C. The oxidation process will be described in detail below.

The oxidized surface functionality may enhance dispersion of the treatment agent in the carrier fluid compared to the dispersion of the treatment agent without an oxidized surface functionality. In one or more embodiments, the oxidized surface of the functionality increases homogeneity of the adsorption composition.

In one or more embodiments, the oxidized surface functionality may be covalently linked to one or more carbon atoms on the surface of the treatment agent. In one or more particular embodiments, the surface functionalities have a functional group selected from the group consisting of a hydroxy group (—OH), a ketone, an aldehyde (—CHO), a carboxy group (—COOH), an ester group (—COOR), an anhydride, an ether (—C—O—R), a nitrate group (—NO₃), a nitrite group (—NO₂), a nitrosyl group (—NO), and combinations thereof. In such embodiments, R of the ester group, the ether group, or both, may be another carbon atom on the surface of the carbonaceous material.

The treatment agent including one or more oxidized surface functionalities in accordance with one or more embodiments may have a density in a range with a lower limit of one of about 1.0 grams per cubic centimeter (g/cc), about 1.1 g/cc, about 1.2 g/cc, about 1.3 g/cc, about 1.4 g/cc, about 1.5 g/cc, and about 1.6 g/cc with an upper limit of one of about 1.4 g/cc, about 1.5 g/cc, about 1.6 g/cc, about 1.7 g/cc, and about 1.8 g/cc where a value of the lower limit can be used in combination with a value of a mathematically compatible upper limit.

### PREPARING AN ADSORPTION COMPOSITION

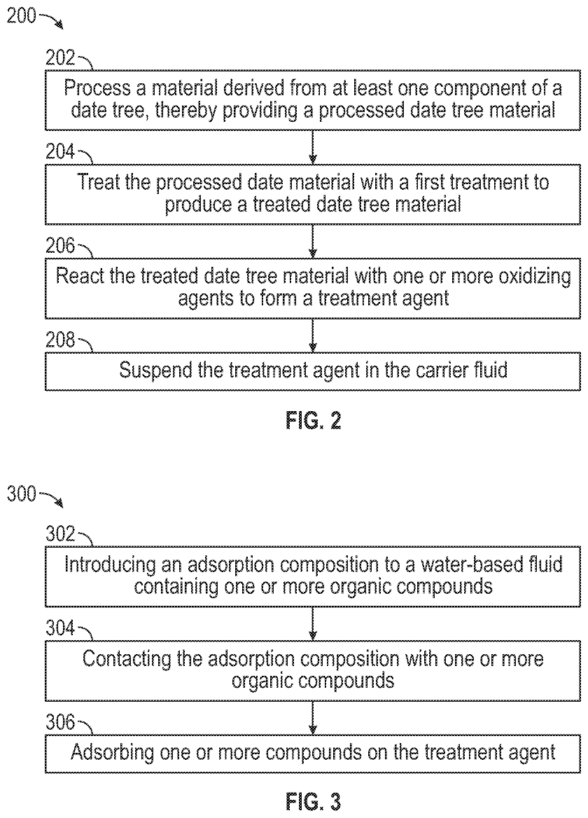

In another aspect, embodiments disclosed herein relates to a method of producing an adsorption composition. FIG. 2 is a block flow diagram of a method 200 of preparing an adsorption composition according to one or more embodiments. The method 200 includes step 202 that includes processing materials derived from at least one component of a date tree, thereby providing a processed date tree material. The at least one component of the date tree may include a fibrous component derived from the date tree as described above. The processing may include cleaning and grinding the fibrous component of the date tree material. The ground fibers may be separated by a sieve to obtain finely sieved fibers in a range from about 0.5 mm to about 4 mm in length.

Once the date tree material has been processed into ground fibers, it may be treated with a first treatment 204. In one or more embodiments, the first treatment includes a treating the sieved fibers with a heat treatment. The heat treatment may include carbonization of the finely sieved fibers. Carbonization may include heating the finely sieved fibers to at least about 450° C. under an inert environment, such as under a flow of nitrogen. The first treatment including heat treating the finely sieved fibers may produce a treated date tree material, such as a char.

In step 206 of FIG. 2, the treated date tree material may be reacted with one or more oxidizing agents to form a treatment agent. In one or more embodiments, reacting the treated date tree material with one or more oxidizing agents includes oxidizing the treated date tree material. In such embodiments, oxidizing the treated date tree material includes reacting the treated date tree material with a first oxidizing agent to form a first oxidized date tree material. The first oxidizing agent may be a chemical selected from the group consisting of chlorine (Cl₂), nitric acid (HNO₃), nitrate compounds including potassium nitrate (KNO₃) or sodium nitrate (NaNO₃), potassium chlorate (KClO₃), sulfuric acid (H₂SO₄), peroxydisulfuric acid (H₂S₂O₈), hydrogen peroxide (H₂O₂), and combinations thereof. The oxidizing may be performed under inert conditions. In one or more embodiments, oxidizing date tree material may result in a first surface functionalization of the treated date tree material.

In one or more embodiments, the method 200 includes reacting the first oxidized material with a second oxidizing agent to form the treatment agent. In such embodiments, the second oxidizing agent may be selected from the group consisting of nitric acid (HNO₃), sulfuric acid (H₂SO₄), and combinations thereof. The reaction of the first oxidized material with the second oxidizing agent may be performed with mechanical stirring at an elevated temperature, for a period of time to form a crude treatment agent. The reaction of the first oxidized material with the second oxidizing agent at an elevated temperature in a range from a lower limit of any one of about 70° C., about 80° C., about 90° C., about 100° C., about 110° C., and about 120° C. with an upper limit of any one of about 90° C., about 100° C., about 110° C., about 125° C., and about 140° C., where a value of the lower limit can be used in combination with a value of a mathematically compatible upper limit. In one or more embodiments, the crude treatment agent may be washed several times with distilled water to provide a purified treatment agent.

The treatment agent may be suspended in the carrier fluid as described in step 208 of method 200. In one or more embodiments, the method of suspending the treatment agent may include sonicating, mechanical stirring, heating, or combinations thereof. In one or more particular embodiments, the treatment agent may be suspended in the carrier fluid to form the adsorption composition using sonication. In such embodiments, a suspension stabilizer may be added to the carrier fluid to suspend the treatment agent. The suspension stabilizer may be as described above, where the suspension stabilizer may assist in stabilizing the treatment agent to be uniformly suspended in the carrier fluid to form the adsorption composition.

### ADSORBING A COMPOUND FROM A WATER-BASED FLUID

In another aspect, embodiments disclosed herein relates to a method 300 of adsorbing one or more compounds from a water-based fluid as shown in FIG. 3. The method may include step 302 in which an adsorption composition is introduced to a water-based fluid containing one or more organic compounds to form a remediation mixture. The water-based fluid may be an aqueous fluid as described above. The adsorption composition, which includes a treatment agent and a carrier fluid, may be as described above.

In one or more embodiments, the forming the remediation mixture includes determining an amount of the adsorption composition, the treatment agent, or both to introduce to the water-based fluid. The determined amount of the adsorption composition, the treatment agent, or both to introduce to the water-based fluid may be dependent upon a concentration of the one or more organic compounds present in the water-based fluid. In such embodiments, the method includes measuring an initial concentration of the one or more organic compounds in the water-based fluid prior to introducing the adsorption composition to the water-based fluid.

The method may further include contacting the adsorption composition with one or more organic compounds of the remediation mixture as shown in step 304. The one or more organic compounds may be selected from the group consisting of benzene, toluene, ethylbenzene, o-xylene, m-xylene, p-xylene, methyl tert-butyl ether, and combinations thereof. The organic compounds may be present as contaminants in a water-based fluid.

In one or more embodiments, contacting the adsorption composition with one or more organic compounds of the remediation mixture includes agitating the remediation mixture via mechanical stirring, sonication or both. Agitating the remediation mixture may be performed for a period of time with a lower limit of any one of about 5 minutes (min), about 10 min, about 20 min, about 30 min, and about 45 min with an upper limit of any one of about 20 min, 30 min, 40 min, 50 min, and about 60 min, where a value of the lower limit can be used in combination with a value of a mathematically compatible upper limit. In such embodiments, agitating the remediation mixture enhances contact of the one or more organic compounds with the treatment agent of the adsorption composition.

In step 306, one or more one or more organic compounds from the water-based fluid may adsorb on the treatment agent of the adsorption composition. The one or more organic compounds adsorbed on the treatment agent may be extracted from the remediation mixture by filtration separation. The solid treatment agent which includes one or more organic compounds adsorbed to its surface may be readily filtered out from the water-based fluid, thereby providing a water-based fluid with reduced contamination.

In one or more embodiments, the method includes measuring a second concentration of the one or more organic compounds remaining in the water-based fluid. In such embodiments, the method 300 may be repeated to adsorb and extract one or more compounds from the water-based fluid, such that the one or more organic compounds of the water-based fluid is below a threshold concentration. In such embodiments, the extraction of the treatment agent removes the organic compounds such that the water-based fluid is purified. Thus, the disclosed composition may be readily applied for environmental remediation.

### EXAMPLES

### Materials

Nitric acid, hydrogen peroxide (5% aqueous solution), polyethyleneimine, and nitrogen were obtained from Sigma-Aldrich. Date palm fibers were obtained from local sources from Dhahran, Saudi Arabia, Khobar, Saudi Arabia, and Dammam, Saudi Arabia.

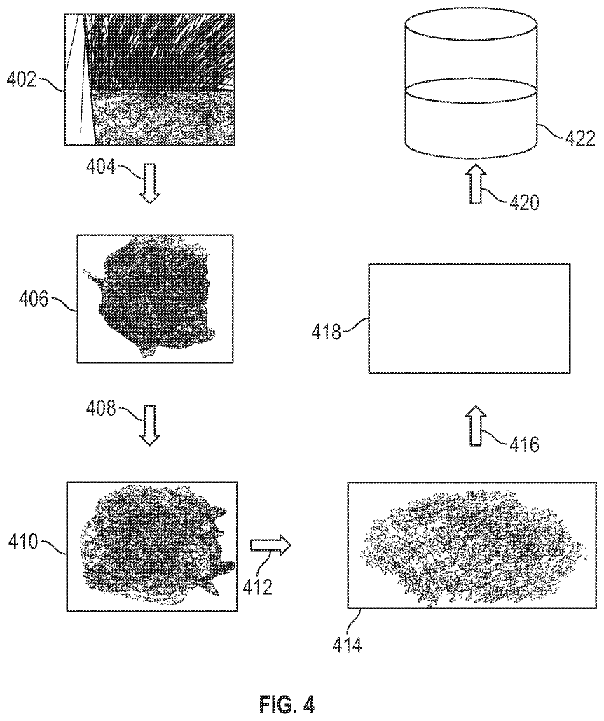

Referring now to FIG. 4, date palm fibers 402 were cleaned and manually ground with a mortar and pestle as represented by arrow 404 to produce ground fibers 406. The palm fibers were cleaned by rinsing with water and acetone to remove adhesive components from the fibers. The ground fibers 406 were separated by a sieve (represented by arrow 408) to finely sieve and obtain the fibers with sizes with lengths in a range from 1 mm to 2 mm. The finely sieved fibers 410 were then carbonized at 450° C. under a flow of nitrogen (99.9%) flow in a stainless-steel vertical tubular reactor placed in a tube furnace to obtain a char for 3 to 6 hours.

Arrow 412 of FIG. 4 represents the chemical treatments to the char. To the char, 5% hydrogen peroxide solution was introduced, and the char to hydrogen peroxide ratio was 1 wt. % (weight percent) to 10 wt. % based on the total weight of the chemical treatment mixture. The mixture was flushed with nitrogen (99.9%) to remove the air and oxygen. After 10 h (hours) of mechanical stirring, the mixture was filtered to obtain a carbon black material 414.

The carbon black material 414 was further oxidized via treatment with nitric acid as represented by arrow 416. In this process, nitric acid (1 Molar) was added into the carbon black in a ratio of 20 mL nitric acid to 1 g carbon black. The mixture was then heated to about 90° C. and maintained under reflux while stirring for 3 h. The mixture was then allowed to cool and was filtered and washed with distilled water several times to obtain the treatment agent 418. The treatment agent 418 was then characterized and determined to have an average surface area of 880 m²/g, a density of 1.3 g/cc, an average particle size of 0.1 μm (centimeters cubed per gram), and an average pore volume of 0.03 cm³/g.

Conversion of the treatment agent 418 to an adsorption composition 422 was performed by mixing the treatment agent 418 with distilled water in a weight ratio of 1 to 10 of the treatment agent to distilled water . The mixture was then sonicated (represented by arrow 420) for 1 h. Polyethylenimine (0.5 wt %) was then added into the mixture as a suspension stabilizer. The mixture was further sonicated (also represented by arrow 420) for 5 h to obtain an adsorption composition 422.

Embodiments of the present disclosure may provide at least one of the following advantages. The eco-friendly, non-toxic, and environmentally friendly properties of the date palm fiber formulation may minimize or prevent any environmental impact, any effect on ecosystems, habitats, population, crops, water sources, and plants surrounding the site where the date palm fiber is used.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An adsorption composition comprising:
a treatment agent comprising a material having an oxidized surface functionality, wherein he material is selected from the group consisting of pyrolyzed carbon, activated carbon, and combinations thereof; and
a carrier fluid.

2. The composition of claim 1, wherein the carrier fluid is an aqueous fluid.

3. The composition of claim 1, wherein the treatment agent has a surface area ranging from about 600 m²/g to about 1500 m²/g.

4. The composition of claim 1, wherein the treatment agent has a density in a range of about 1.0 g/cc to about 1.8 g/cc.

5. The composition of claim 1, wherein the treatment agent is derived from at least one component of a date tree.

6. The composition of claim 5, wherein the at least one component of the date tree comprises a fibrous component having an average diameter in the range of about 50 nm to about 0.1 μm and an average length of about 0.5 mm to about 4.0 mm.

7. The composition of claim 1, wherein the treatment agent is configured to adsorb one or more compounds from a water-based fluid.

8. The composition of claim 7, wherein the one or more compounds are organic compounds selected from the group consisting of benzene, toluene, ethylbenzene, o-xylene, m-xylene, p-xylene, methyl tert-butyl ether, and combinations thereof.

9. The composition of claim 1, comprising from about 1 to about 20 wt. % (weight percent) of the treatment agent based on the total weight of the carrier fluid.

10. A method of preparing an adsorption composition, the method comprising:
processing a material derived from at least one component of a date tree, thereby providing a processed date tree material, wherein the at least one component of the date tree comprises a fibrous component derived from the date tree;
treating the processed date tree material with a first treatment to produce a treated date tree material;
reacting the treated date tree material with one or more oxidizing agents to form a treatment agent; and
suspending the treatment agent in a carrier fluid.

11. The method of claim 10, wherein reacting the treated date tree material with one or more oxidizing agents comprises:
reacting the treated date tree material with a first oxidizing agent to form a first oxidized date tree material; and
reacting the first oxidized material with a second oxidizing agent to form the treatment agent.

12. The method of claim 11, wherein the first oxidizing agent comprises hydrogen peroxide and the second oxidizing agent comprises nitric acid.

13. The method of claim 10, wherein treating the processed date tree material with a first treatment comprises carbonizing the processed date tree material.

14. The method of claim 10, wherein suspending the oxidized date tree material comprises sonicating the treatment agent in the carrier fluid.

15. A method of adsorbing one or more compounds from a water-based fluid comprising:
introducing an adsorption composition to a water-based fluid containing one or more organic compounds, wherein the adsorption composition comprises:
a treatment agent comprising a material having an oxidized surface functionality, wherein the material is selected from the group consisting of pyrolyzed carbon, activated carbon, and combinations thereof; and
a carrier fluid; and
contacting the adsorption composition with the one or more organic compounds; and
adsorbing the one or more organic compounds on the treatment agent.

16. The method of claim 15, further comprising measuring an initial concentration of the one or more organic compounds in the water-based fluid prior to introducing the adsorption composition to the water-based fluid.

17. The method of claim 15, wherein the one or more organic compounds are selected from the group consisting of benzene, toluene, ethylbenzene, o-xylene, m-xylene, p-xylene, methyl tert-butyl ether, and combinations thereof.

18. The method of claim 15, further comprising extracting the treatment agent having the one or more adsorbed compounds from the water-based fluid, thereby purifying the water-based fluid.

19. The method of claim 17, further comprising:
separating the treatment agent having the one or more adsorbed compounds from the water-based fluid via filtration; and
measuring a second concentration of the one or more organic compounds remaining in the water-based fluid.

20. The method of claim 15, further comprising providing the treatment agent derived from one or more components, wherein the treatment agent has a surface area ranging from about 600 m²/g to about 1500 m²/g and a density in a range of about 1.0 g/cc to about 1.8 g/cc g/mL.
